(19) United States
(12) Patent Application Publication
(10) Pub. No.: US 2009/0184037 A1
(43) Pub. Date: Jul. 23, 2009

(54) MEMBRANE STRUCTURE FOR GAS SEPARATION

(76) Inventors: Ralf-Peter Peters, Bergisch-Gladbach (DE); Wolfgang Stoeters, Muelheim/Ruhr (DE); Mario Hempel, Dortmund (DE); Holger Holakovsky, Witten (DE)

Correspondence Address: MICHAEL P. MORRIS;BOEHRINGER INGELHEIM USA CORPORATION, 900 RIDGEBURY RD, P. O. BOX 368, RIDGEFIELD, CT, 06877-0368, US

(21) Appl. No.: 12/278,812

(22) PCT Filed: Feb. 19, 2007
(86) PCT No.: PCT/EP07/01409

§ 371 Date: Sep. 4, 2008

(30) Foreign Application Priority Data
Feb. 17, 2006 (DE) 10 2006 007 868.3

(51) Int. Cl. B01D 19/00; B01D 69/12; B01D 67/00; B01D 71/32; B05D 3/00

(52) U.S. Cl. 210/188; 427/385.5

(57) ABSTRACT

A membrane structure for gas separation, a degassing device having such a membrane structure, and also method for production of the same are proposed. A porous carrier layer is joined flat to a thin polymer membrane, in particular made of amorphous PTFE. In particular, the polymer membrane is produced on or from the carrier layer. This makes possible a simple and inexpensive structure and also an effective gas separation. Particularly preferable, the polymer membrane is formed by applying a polymer solution in the liquid state to the carrier layer and drying it.

The present invention relates to a process for producing a membrane structure, a membrane structure for gas separation and a degassing apparatus having a membrane structure of this kind.

The present invention relates in particular to the field of degassing a liquid in which reduced pressure or a vacuum is applied on the gas side in order to separate gas from the liquid through a membrane which is permeable only by gas but not by the fluid. It is desirable if the membrane or the membrane structure used is highly permeable to the gases that are to be separated off.

The above-mentioned underpressure or vacuum degassing is used in particular for so-called liquid chromatographs, most preferably so-called high performance liquid chromatography (HPLC). This is a preferred field of application of the present invention. However, the present invention is not restricted to this field.

For degassing liquids, various degassing apparatus is used in chemical analytical technology, particularly for HPLC.

Conventional PTFE-tube de-gassers have a plurality of thin tubes made of normal PTFE. The tubes or their walls constitute membranes which are permeable only to gases but not to liquids. By a pressure difference gas can diffuse through the membranes or walls and thereby be separated off. The relatively great dead volume is a disadvantage. Particularly when the equipment is used for analyses with low flow rates it leads to very long waiting times when changing the liquid or when starting up, i.e. at the beginning of an analysis. The thickness of the membrane corresponds to the required thickness of the tube wall and depends not only on the mechanical requirements but also on the manufacturing process. The considerable wall thickness does not ensure optimum effectiveness of gas separation.

U.S. Pat. No. 6,309,444 B1 discloses a degassing device having a tube made of amorphous PTFE. The improved diffusion or permeation properties of this material ensure more effective or improved gas separation and a smaller dead volume. A disadvantage here is that the membrane thickness is determined by the required thickness of the tube wall. Another disadvantage is that amorphous PTFE is very expensive compared with normal or standard PTFE.

EP 0 973 031 A1 discloses a different degassing device. A thin membrane of typically five μm made of normal PTFE is supported by a separate carrier layer on the gas separation side which can be put under vacuum. The carrier layer is porous and consists for example of stretched or extended PTFE filter material about 100 μm thick. The membrane and the carrier layer are produced separately. The membrane is produced in particular by spin coating on a wafer, from which the membrane is then removed. In the installed state the carrier layer is in turn supported by a glass frit. This structure ensures a particularly small dead volume. The membrane thickness is determined primarily by the required mechanical stability. The assembly is relatively difficult, particularly as a relatively large membrane surface is required.

A method of producing a polymer membrane structure for separating oxygen from fuel is also known from EP 1 568 403 A1. A polymer solution is applied to a porous carrier layer of PVDF using a roller and is then dried from the application side. Thus the membrane structure obtained is not optimum.

Other membrane structures are known, for example from WO 98/35739 A1, U.S. Pat. No. 4,990,255 A, U.S. Pat. No. 5,238,471 A, EP 1 559 884 A2, EP 1 559 902 A1, U.S. Pat. No. 5,876,604 A, EP 0 969 025 A1, DE 39 41 861 C1, U.S. Pat. No. 6,896,717 B2, U.S. Pat. No. 6,579,341 B2 and U.S. Pat. No. 6,572,680 B2.

The present invention is based on the problem of providing a process for producing a membrane structure, a membrane structure for gas separation and a degassing apparatus having such a membrane structure, wherein the membrane structure is relatively simple and cheap to produce and/or particularly effective gas separation is made possible.

This objective is achieved according to one of the independent claims. Further features are the subject of the subsidiary claims.

In a first aspect the present invention comprises forming a thin, in particular pore-free polymer membrane on a porous carrier layer from a polymer solution, the polymer solution being dried substantially only from the polymer membrane side which is to be formed (the membrane side) of the carrier layer. This contributes in particular to achieving a particularly pore-free and/or defined structure of the polymer membrane, most preferably in the manner of a skin on the carrier layer or an intermediate layer optionally provided in between.

In one aspect the present invention comprises joining a thin polymer membrane which is permeable to gases but not to liquids indirectly or directly to a porous carrier layer over its area. This makes manufacture considerably easier, particularly when the polymer membrane is produced on or from the carrier layer, as is preferably envisaged.

According to an alternative or additional aspect the pore volume decreases towards the membrane side and/or is reduced in an edge region of the carrier layer adjacent to the membrane side, particularly by the incorporated polymer of the polymer membrane.

Furthermore, the embodiment mentioned above permits a substantially thinner construction of the polymer membrane as the latter can be optimally stabilised and held by the carrier layer. The thinner construction of the polymer membrane ensures more effective gas separation as the diffusion resistance for the gas decreases accordingly as the thickness is reduced.

Most preferably, the polymer membrane consists at least substantially of amorphous PTFE (polytetrafluoroethylene and/or the copolymers thereof). This constitutes a substantial improvement in the gas separation as amorphous PTFE has substantially higher permeability for gases compared with conventional PTFE, i.e. a higher degree of perviousness or lower diffusion resistance.

A further advantage of the thin structure of the polymer layer is that particularly when using amorphous PTFE to form the polymer layer favourable production is made possible by the low consumption of materials.

The proposed membrane structure is used in particular as a flat or planar membrane. Alternatively, the membrane structure is tubular in shape. In this case the polymer layer may be provided on the inside and/or outside.

A degassing device with a proposed membrane structure allows particularly effective degassing and is correspondingly particularly suitable for chemical analysis technology such as HPLC.

One method of producing the membrane structure is characterised in that a polymer solution is applied to the carrier layer or to an intermediate layer provided thereon and dried so as to form the polymer layer. This can if necessary be repeated at least once in order to ensure that any holes that may appear during the first membrane formation can be reliably closed up, i.e. a continuous or sealed polymer layer can be obtained as the membrane, which is impervious to liquids. Using the proposed process it is very easy to produce very thin yet leak-tight polymer layers or membranes.

According to another process a polymer is evaporated onto the carrier layer or an intermediate layer provided thereon, so as to form the polymer layer. This also ensures simple inexpensive manufacture.

Another method of producing the membrane structure is characterised in that the carrier layer is compacted on a flat side by the application of heat and/or pressure in order to reduce the pore size in the region of this flat side and/or to form the polymer layer or the intermediate layer. Thus, once again, simple or inexpensive production is made possible. The reduction in the pore size on the flat side of the carrier layer that carries the polymer layer assists, in particular, with the formation of a very thin but continuous or leak-tight and, more particularly, unperforated polymer layer on this flat side.

Another process is characterised in that the polymer layer is formed on a carrier layer which is non-porous or only slightly porous, and the layer is then foamed. Alternatively, a fifth process envisages that a thick amorphous polymer layer is foamed in a partial thickness range so as to form the porous carrier layer in the foamed thickness region and form the thin polymer layer in the remainder of the thickness region. In both cases this results in a very simple inexpensive manufacture of the membrane structure.

Further aspects, features, properties and advantages of the present invention will become apparent from the claims and the following description of preferred embodiments with reference to the drawings, wherein:

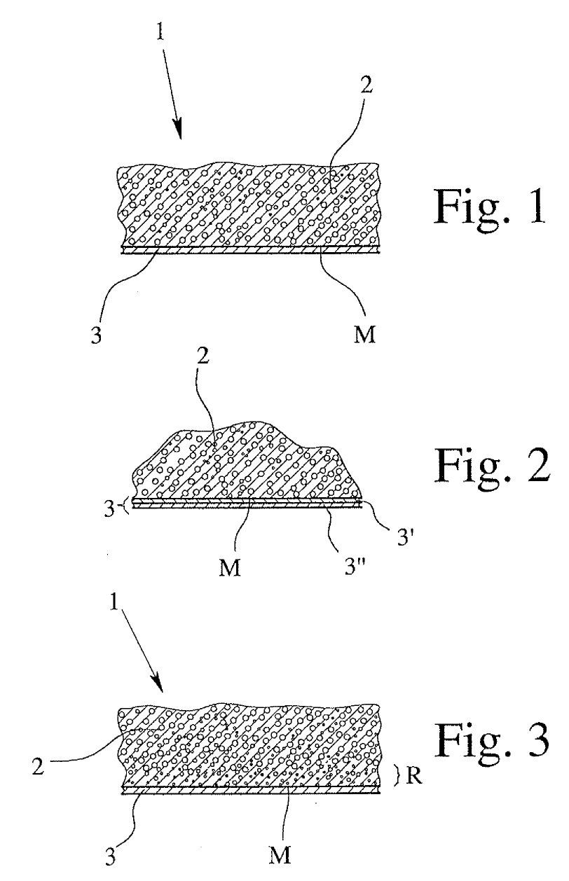

FIG. 1 shows a schematic section, not to scale, through a proposed membrane structure according to a first embodiment;

FIG. 2 shows a magnification of a detail from FIG. 1;

FIG. 3 shows a schematic section, not to scale, through a proposed membrane structure according to a second embodiment;

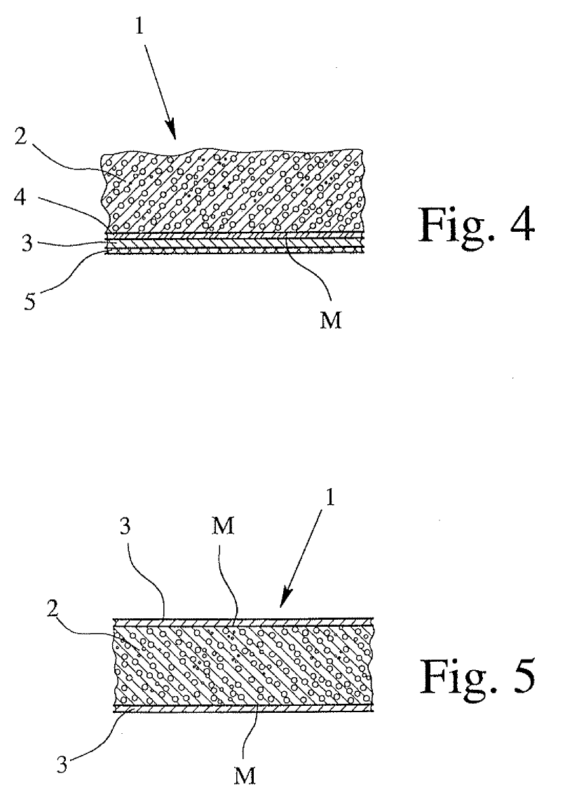

FIG. 4 shows a schematic section, not to scale, through a proposed membrane structure according to a third embodiment;

FIG. 5 shows a schematic section, not to scale, through a proposed membrane structure according to a fourth embodiment;

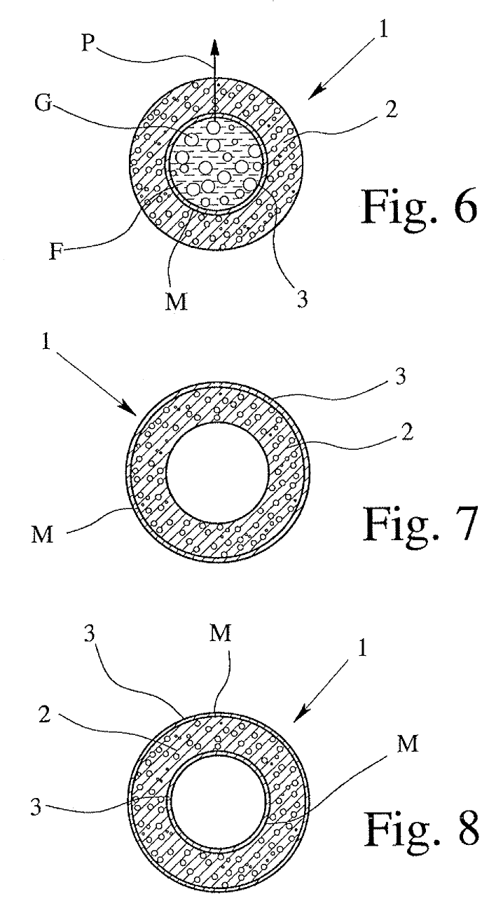

FIG. 6 shows a schematic section, not to scale, through a proposed membrane structure according to a fifth embodiment;

FIG. 7 shows a schematic section, not to scale, through a proposed membrane structure according to a sixth embodiment;

FIG. 8 shows a schematic section, not to scale, through a proposed membrane structure according to a seventh embodiment; and

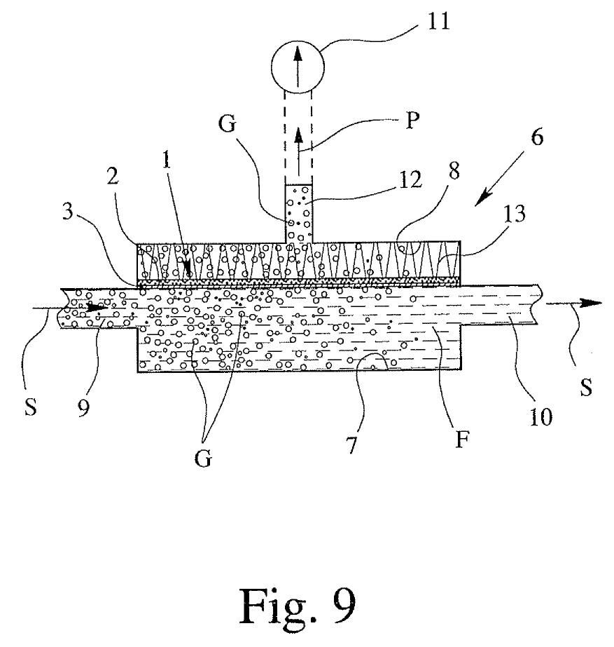

FIG. 9 shows a schematic section, not to scale, through a proposed degassing apparatus having a membrane structure of the proposed kind.

In the Figures, the same reference numerals have been used for identical or similar parts and components; identical or similar properties, effects and/or advantages are obtained, even where the repeated description has been omitted.

FIG. 1 shows a proposed membrane structure 1 according to a first embodiment. The membrane structure 1 has a porous carrier layer 2 and a thin polymer membrane 3 which is connected directly or indirectly thereto over its surface. The membrane structure 1 allows the separation of gas particularly from a liquid phase or liquid, as will be explained in detail hereinafter by reference to FIG. 9. The polymer membrane 3 is permeable or pervious to gases but not to liquids. The polymer membrane 3 thus forms the functional layer of the membrane structure 1.

The carrier layer 2 serves in particular as a substrate during the production of the polymer layer 3 and for stabilising and securing the polymer layer 3, which can accordingly be made particularly thin. The polymer membrane 3 has, in particular, a thickness of less than 5 μm. Preferably the thickness is 1 to 4 μm particularly substantially 2 μm. In particular, the thickness of the polymer membrane 3 is less than 10% of the thickness of the membrane structure 1 or of the carrier layer 2. Because of the small thickness the permeability or perviousness to gas is very high, i.e. the diffusion resistance through the polymer layer 3 is relatively low, thus enabling particularly effective gas separation.

The polymer membrane 3 preferably consists at least substantially of amorphous PTFE (polytetrafluoroethylene and/or the copolymers thereof), particularly the PTFE which is obtainable from DuPont under the brand name “Teflon AF”, e.g. “Teflon AF 2400”.

The polymer membrane 3 is most preferably produced from a polymer solution, particularly a solution of amorphous PTFE. This will be described in more detail.

Amorphous PTFE has the advantage, over conventional or standard PTFE, that its permeability or perviousness to gases is considerably higher. Accordingly, when using amorphous PTFE for the polymer membrane 3, a substantially lower diffusion resistance is obtained, i.e. a substantially higher permeability or perviousness and hence separation of gases for the same layer thickness.

The particularly thin construction of the polymer membrane 3 is also very advantageous from the point of view of costs, particularly when using amorphous PTFE, as it is very expensive.

Most preferably, the polymer membrane 3 is produced on or from the carrier layer 2. This will be described in more detail hereinafter.

In order to achieve a full-surface and/or particularly secure attachment of the polymer membrane 3 to the carrier layer 2, the polymer membrane 3 is preferably fused onto the carrier layer 2 or vice versa. This can be done in particular by heating it for a correspondingly brief period to above the melting temperature.

The polymer membrane 3 may itself be made in one or more layers. FIG. 2, which shows a magnified detail from FIG. 1, illustrates as an embodiment by way of example a two-ply structure of the polymer membrane 3 consisting of the two polymer layers 3′ and 3″. A first particularly preferred process for the proposed manufacture of this structure is described hereinafter.

First of all, the carrier layer 2 is produced or prepared. The carrier layer 2 is of porous construction, i.e. permeable to gases and liquids. The mean or maximum pore size is 0.1 to 10 μm, for example, preferably 0.2 to 5 μm, particularly less than 1 μm and most preferably about 0.2 to 0.4 μm.

The carrier layer 2 is preferably made of polymer, particularly standard PTFE, PVDF or polyethylene such as UHMW-PE. The desired porosity can be achieved by stretching or extending, for example.

The thickness of the carrier layer 2 is preferably less than 250 μm, particularly 10 to 100 μm, most preferably 20 to 50 μm.

According to a first process a polymer solution, more preferably a solution of amorphous PTFE, especially “Teflon AF”, is applied to the carrier layer 2 and dried in order to form the polymer layer 3.

According to a first alternative embodiment, the polymer solution is applied by immersing the carrier layer 2 in the polymer solution. However, the carrier layer 2 may also be impregnated with the polymer solution by some other method.

Then the polymer solution is dried, starting from a flat side or surface (membrane side M) of the carrier layer 2, from below in FIG. 1, in particular. The result of this is that the polymer membrane 3 is formed in the desired manner, namely very thin and leak-tight, particularly in the manner of a skin, on this flat side or surface of the carrier layer 2 (i.e. in particular at the bottom of FIG. 1). During the drying the still fluid polymer solution retracts onto the membrane side M or drying side of the membrane structure 1, preferably as a result of surface tension and/or capillary effects. In this way, continuous and leak-tight (pore-free) polymer membranes 3 or layers 3′, which are thus impervious to liquids, can be formed, the thickness being in particular less than 5 μm, more preferably 2 μm or less, especially around 1 μm or even less.

In addition or alternatively to the one-sided drying mentioned above, the polymer solution may also be deposited or concentrated on the desired flat side or surface of the carrier layer 2, as a result of forces of acceleration acting in the direction of thickness of the structure 1, for example during centrifuging or rotation of the carrier layer 2, and/or by pressure, for example by applying reduced pressure or vacuum to the membrane side M of the carrier layer 2, in order to form the polymer membrane 3 in the desired manner.

The above-mentioned one-sided precipitation or arrangement of the polymer solution may additionally or alternatively be achieved or assisted by corresponding capillary forces. In particular, the capillarity of the carrier layer 2 increases towards the flat side or surface on which the polymer membrane 3 is to be formed, for example by suitable variation or reduction of the mean or maximum pore size.

After the drying or final drying of the polymer solution, e.g. for more than ten hours at ambient temperature, it may optionally additionally be subjected to drying in the drying cupboard for more than ten minutes, for example, in order to release the solvent from the polymer solution, e.g. at a temperature of the order of or more than 150° C.

Some embodiments and variants as well as processes will now be described. Only essential differences between them will be emphasised. The remarks made hitherto apply in a supplementary or corresponding manner otherwise.

Alternatively, the polymer solution may be applied according to a second embodiment by so-called spin coating (uniform distribution of the polymer solution by rotation on a surface) or by spraying, scraping or dispensing (particularly by the application of liquid and uniform distribution, for example by use or surface tension).

As already mentioned there is the optional possibility of achieving a particularly firm connection between the carrier layer 2 and the polymer membrane 3 by fusing the polymer membrane 3 onto the carrier layer 2 or vice versa.

By the melting or fusion mentioned above or a separate optional sintering step the crystallinity particularly of the polymer membrane 3 can also be suitably modified so as to achieve the desired properties, especially in terms of the permeability or perviousness to gases.

In the first embodiment the polymer membrane 3 is preferably constructed in at least two plies, as indicated in FIG. 2. After the formation of the first polymer layer 3′, before or after the optional release of the desiccant in the drying cupboard and/or the optional fusion, as desired—the second polymer layer 3″ is formed as in the embodiments shown, particularly by the application of a polymer solution and drying, once again. The second layer 3″ may in particular close up any holes, pores, openings or the like which may be present in the first layer 3′, so that the polymer membrane 3 formed from the two layers 3′ and 3″ is continuous and leak-tight, i.e. impervious to liquids.

The application of the polymer solution for the second layer 3″ may in particular be carried out by a different method from the application of the polymer solution for the first layer 3′.

Instead of applying a polymer solution, alternatively or additionally, according to a second process, the polymer material that forms the polymer membrane 3 can also be applied by vapour deposition or in some other suitable manner, e.g. by sputtering. If necessary, the desired formation of the polymer membrane 3 from the polymer material can be carried out by subsequent treatment, e.g. fusion.

In order to form a flat side or substrate for the polymer membrane 3 which is as smooth and continuous as possible it is advantageous for the carrier layer 2 to have a small pore size or low porosity. According to one alternative embodiment, the pore size and/or density of the carrier layer 2 then decreases over the thickness of the carrier layer 2 to the polymer layer 3 or is at least reduced in the region of the flat side of the carrier layer 2 facing the polymer membrane 3, as indicated in the second embodiment according to FIG. 3. The latter can be achieved, in particular, by modifying the carrier layer 2 on this flat side by the application of heat and/or pressure, e.g. by fusion and/or compaction.

Additionally or alternatively, some other chemical and/or mechanical treatment is also possible in order to render the flat side of the carrier layer 2 facing the polymer membrane 3 as smooth and/or pore free as possible or to give it only fine pores in order to facilitate or assist with the formation of a continuous and leak-tight thin polymer membrane 3.

Particularly preferably, according to an additional or alternative aspect, it is envisaged that the pore volume of the carrier layer decreases towards the membrane side M and/or is reduced in an edge region of the carrier layer adjacent to the membrane side M, as indicated in FIG. 3. This is achieved particularly preferably by means of polymer of the polymer membrane 3 incorporated in the carrier layer 2, particularly only in an edge region R of the carrier layer 2 adjacent to the membrane side M. This is most preferably done during the one sided drying of the polymer solution, in which the process parameters are selected such that the polymer solution cannot retract completely onto the membrane side M from the carrier layer 2 when dried.

In order to provide or improve adhesion and/or to yield a surface or substrate for the polymer membrane 3 which is as smooth and pore-free as possible and/or at least has only small pores, an intermediate layer 4 is optionally provided between the carrier layer 2 and the polymer membrane 3. The third embodiments of the proposed membrane structure 1 shown in a schematic section in FIG. 4, which is not to scale, shows an intermediate layer 4 of this kind which is first formed on the carrier layer 2 and on which the polymer membrane 3 is then formed, as described in particular above or hereinafter.

The intermediate layer 4 is preferably pore-free in construction or has, in particular, only substantially smaller pores than the carrier layer 3. For example, the intermediate layer 4 consists of a polymer, particularly a normal pore-free PTFE.

Alternatively, the intermediate layer 4 may also be formed by corresponding compaction and/or other modification—for example by melting, chemical treatment or the like—of a sickness region of the carrier layer 2. According to a third process, the carrier layer 2 may be compacted on a flat side by heat and/or pressure in order to form the polymer membrane 3 or the intermediate layer 4, as already discussed.

According to a fourth process, the polymer membrane 3 is formed on a carrier layer 2 with little or no porosity, which is foamed. The foaming may be carried out for example using an inflating agent and/or by heating or by some other suitable method.

According to a fifth proposed process, a thick amorphous polymer layer is foamed in a partial thickness region in order to form the porous carrier layer 2 in the foamed thickness region and the thin polymer membrane 3 in the remaining thickness region.

According to another aspect which can also be implemented independently of the proposed membrane structure 1 described hereinbefore and/or the manufacturing methods, the polymer membrane 3 can be covered with an optional protective layer 5, as shown in FIG. 4. The protective layer 5 serves in particular to protect the polymer membrane 3 from mechanical and/or chemical effects. This applies in particular when the polymer membrane 3 consists at least essentially of amorphous PTFE, which is not resistant to certain solvents, for example. The protective layer 5 is then constructed so that it is resistant to as many common solvents as possible. For this purpose the protective layer 5 is produced for example from normal pore-free PTFE or another suitable polymer with sufficiently great permeability or perviousness to the gases which are to be separated off. Because the protective layer 5 can be made very thin and may have a thickness of only about 1 μm, in particular, even more effective or better separation of gases is possible than in the prior art.

The protective layer 5 preferably covers the polymer layer 3 completely, at least in the areas that come into contact with liquid and/or in the areas exposed to mechanical stresses or effects.

It should be noted that the formation or preparation of the intermediate layer 4 and/or of the protective layer 5 may be carried out according to the manufacture of the polymer membrane 3 or by some other suitable method.

FIG. 5 shows in a schematic section, not to scale, a fourth embodiment of the proposed membrane structure 1. Here, the porous carrier layer 2 is provided on both sides—i.e. on both its flat sides—with a polymer membrane 3 as described above.

The explanations given above for the two polymer membranes 3 apply accordingly. If necessary, the two polymer membranes 3 may also be of different construction and/or produced by different methods.

The membrane structure 1 is preferably smooth or flat according to the embodiments shown in FIGS. 1 to 5 and in particular are of planar construction. Most preferably the membrane structure 1 is also used in this form, e.g. for gas separation.

However, the membrane structure 1 may also have a different form, in particular, adapted to the respective intended use.

The schematic section, not to scale, in FIG. 6 shows a fifth embodiment. The membrane structure 1 here is of hollow cylindrical or tubular construction, particularly in the form of a tube. In the fifth embodiment the polymer membrane 3 forms an internal lining on the wall formed by the carrier layer 2. In the sixth embodiment shown in FIG. 7 the polymer membrane 3 is provided not on the inside but on the outside. In the seventh embodiment shown in FIG. 8 a polymer membrane 3 is provided or formed both on the inside and on the outside.

The membrane structure 1 of tubular construction, particularly as shown in the fifth and seventh embodiments, can be used particularly as a gas-permeable pipe or gas-permeable hose for degassing equipment, preferably as described in U.S. Pat. No. 6,309,444 B1. In particular, fluid F is piped through the interior, as shown in FIG. 6. Gases G contained in the fluid F are then given off radially outwards, as a result of the pressure difference applied, as illustrated by the arrow P. The pressure difference can be produced for example by applying reduced pressure or vacuum on the outside and/or by increasing the pressure of the fluid F on the inside.

Theoretically, however, it is also possible to carry out degassing in the opposite direction, particularly by using the sixth or seventh embodiment. In this case, the gas separated off is discharged into the interior of the tubular membrane structure 1. The surface area of the outer polymer membrane 3 is substantially greater than that of the polymer membrane 3 on the inside, so as to enable even more effective separation under otherwise identical pressure conditions from the liquid (not shown) flowing around the outside of the membrane structure 1.

FIG. 9 shows in a schematic section, not to scale, a proposed degassing apparatus 6 with a proposed membrane structure 1. The membrane structure 1 separates a chamber 7 for the fluid F which is to be degassed from a chamber 8 for discharging the gas G which has been separated off. The polymer membrane 3 faces the fluid side; the porous carrier layer 2 is thus arranged on the gas side.

The fluid F can be supplied, in particular, in the direction S through an inlet 9 to the chamber 7, preferably can be conveyed parallel or flatly through the membrane structure 1 or the polymer membrane 3 and can be discharged again through an outlet 10, for example to a chemical analyser (not shown) such as a liquid chromatograph or the like.

The chamber 8 for discharging the gas is connected to an under pressure or vacuum pump 11, particularly via a connector or outlet 12. Thus, reduced pressure or vacuum can be produced in the chamber 8 in order to bring about the desired separation of gas G from the liquid F by diffusion through the polymer membrane 3, i.e. through the membrane structure 1.

Alternatively or additionally to the reduced pressure or vacuum in the chamber 8, the fluid F in the chamber 7 can be subjected to excess pressure in order to generate or increase the desired pressure difference for the separation of gas.

On the gas side the membrane structure 1 or the carrier layer 2 is preferably supported by a suitable support body 13, provided with projections or ribs, for example, such as a glass frit or the like.

Generally speaking:

The proposed membrane structure 1 allows particularly effective gas separation as it is possible to achieve high perviousness or permeability for the gas G which is to be separated off. Moreover, particularly when using amorphous PTFE, the costs are comparatively low as the polymer membrane 3 proposed can be made very thin.

The optional protective layer 5 also allows even amorphous PTFE or other polymers which are not normally sufficiently stable against chemicals to be used universally.

The individual features, aspects, preparation steps and the like of the different embodiments may also be combined with one another as desired or used or combed for other membrane structures or degassing apparatus.

1. Process for producing a membrane structure (1) for gas separation,
wherein on one membrane side (M) of a porous carrier layer (2) a thin polymer membrane (3) is formed which is permeable to gas (G) but not to fluid (F) and which is directly or indirectly connected over its surface to a flat side or surface of the carrier layer (2),
wherein the carrier layer (2) in order to form the polymer membrane (3) is impregnated with a polymer solution or is immersed therein,
wherein the polymer solution is substantially dried only starting from the membrane side (M), so that the polymer solution at least essentially retracts from the carrier layer (2) to the membrane side (M) in order to form the polymer membrane (3) on the membrane side (M) and in particular to reduce the pore volume of the carrier layer (2) in an edge region (R) of the carrier layer (2) adjacent to the polymer membrane (3).

2. Process according to claim 1, characterised in that the polymer membrane (3) is formed directly on a surface or flat side of the carrier layer (2) or indirectly, particularly via an intermediate layer (4) on one surface or flat side of the carrier layer (2).

3. Process according to claim, characterised in that the polymer solution is at least substantially precipitated on the membrane side (M) of the carrier layer (2) or intermediate layer (4) by acceleration in the direction of thickness and/or by the application of reduced pressure.

4. Process according to claim 3, characterised in that after drying the polymer membrane (3) is fused onto the carrier layer (2) or intermediate layer (4).

5. Process according to claim 4, characterised in that after the formation of a first polymer layer (3′) a second polymer layer (3″) is formed thereon, in particular by the second application of a polymer solution and drying, while in particular after the drying of the second polymer layer (3″) the latter is fused onto the first polymer layer (3′).

6. Process for preparing a formed membrane structure (1) for gas separation, which comprises a porous carrier layer (2) and a thin polymer membrane (3) indirectly connected thereto, particularly via an intermediate layer (4) or directly connected thereto over its surface, said polymer membrane (3) being permeable to gas (G) but not to fluid (F), wherein a polymer is vapour deposited onto the carrier layer (2) or an intermediate layer (4) provided thereon, so as to form the polymer layer (3).

7. Process according to claim 6, characterised in that after the vapour deposition the polymer is fused onto the carrier layer (2) or intermediate layer (4) in order to form the polymer layer (3).

8. Process for preparing a membrane structure (1) for gas separation which comprises a porous carrier layer (2) and a thin polymer membrane (3) connected indirectly thereto via an intermediate layer (4) in particular, or connected directly thereto over its surface, said polymer membrane (3) being permeable to gas (G) but not to fluid (F), wherein the carrier layer (2) is compacted on a flat side by the application of heat and/or pressure in order to reduce the pore size and/or density in the region of this flat side and/or in order to form the polymer layer (3) or the intermediate layer (4).

9. Process according to claim 8, characterised in that the polymer layer (3) is then produced on the carrier layer (2) or intermediate layer (4) according to one of claims 1 to 7.

10. Process for preparing a membrane structure (1) for gas separation which comprises a porous carrier layer (2) and a thin polymer membrane (3) connected indirectly thereto via an intermediate layer (4) in particular, or connected directly thereto over its surface, said polymer membrane (3) being permeable to gas (G) but not to fluid (F), wherein the polymer layer (3) is formed on a carrier layer (2) of little or no porosity, which is foamed.

11. Process for preparing a membrane structure (1) for gas separation which comprises a porous carrier layer (2) and a thin polymer membrane (3) connected indirectly thereto via an intermediate layer (4) in particular, or connected directly thereto over its surface, said polymer membrane (3) being permeable to gas (G) but not to fluid (F), wherein a thick amorphous polymer layer is foamed in a partial thickness range in order to form the porous carrier layer (2) in the foamed thickness region and the thin polymer layer (3) in the remaining thickness region.

12. Membrane structure (1) for gas separation, having a porous carrier layer (2) and a thin polymer membrane (3) which is directly or indirectly connected thereto over its surface, said polymer membrane (3) being permeable to gas (G) but not to fluid (F), the membrane structure (1) being produced in particular according to claim 1, wherein the pore volume of the carrier layer (2) decreases towards the membrane side (M) and/or is reduced in an edge region (R) of the carrier layer (2) adjacent to the polymer membrane (3).

13. Membrane structure according to claim 12, characterised in that the pore volume of the carrier layer (2) decreases or is reduced by incorporated or introduced polymer of the polymer membrane (3).

14. Membrane structure (1) for gas separation, particularly according to claim 13, having a porous carrier layer (2) and a thin polymer membrane (3) attached directly or indirectly thereto over its surface, said polymer membrane (3) being permeable to gas (G) but not to fluid (F), the polymer membrane (3) having been fused onto the carrier layer (2) or vice versa.

15. Membrane structure (1) for gas separation, particularly according to claim 14, having a porous carrier layer (2) and a thin polymer membrane (3) directly or indirectly attached thereto over its surface, said polymer membrane being permeable to gas (G) but not to fluid (F), while between the carrier layer (2) and the polymer membrane (3) there is an intermediate layer (4), particularly as an adhesion promoter.

16. Membrane structure according to claim 15, characterised in that the intermediate layer (4) has a smaller pore size and/or pore density than the carrier layer (2) or is at least substantially pore-free in its construction.

17. Membrane structure (1) for gas separation, particularly according to claim 16, having a porous carrier layer (2) and a thin polymer membrane (3) which is directly or indirectly connected thereto over its surface, said polymer membrane being permeable to gas (G) but not to fluid (F), the polymer membrane (3) being covered by a protective layer (5).

18. Membrane structure according to claim 17, characterised in that the polymer membrane (3) consists at least substantially of amorphous PTFE and/or is formed by a polymer solution dried onto the carrier layer (2) or an intermediate layer (4).

19. Membrane structure according to claim 18, characterised in that the polymer membrane (3) has a thickness of less than 5 μm, preferably 1 to 4 μm, particularly substantially 2 μm, and/or the polymer membrane (3) has a thickness of less than 10% of the thickness of the membrane structure (1) or of the carrier layer (2).

20. Membrane structure according to claim 19, characterised in that the polymer membrane (3) is constructed with one or more layers and/or is of pore-free construction.

21. Membrane structure according to claim 20, characterised in that the polymer membrane (3) is produced on or from the carrier layer (2).

22. Membrane structure according to claim 21, characterised in that the carrier layer (2) is made of polymer, particularly PTFE, PVDF or a polyethylene such as UHMW-PE.

23. Membrane structure according to claim 22, characterised in that the carrier layer (2) has a mean or maximum pore size of 0.1 to 10 μm, particularly 0.2 to 5 μm.

24. Membrane structure according to claim 23, characterised in that the pore size and/or density of the carrier layer (2) varies over the thickness of the carrier layer (2), and particularly decreases towards the polymer membrane (3).

25. Membrane structure according to claim 24, characterised in that the carrier layer (2) is compacted and/or fused in the region of the polymer membrane (3) in order to reduce the pore size and/or density of the carrier layer (2) or form the polymer membrane (3).

26. Membrane structure according to claim 25, characterised in that the carrier layer (2) has a density of less than 250 μm, preferably 10 to 100 μm, particularly 20 to 50 μm.

27. Membrane structure according to claim 26, characterised in that the membrane structure (1) is of flat or smooth and/or uniformly thick construction.

28. Membrane structure according to claim 27, characterised in that the membrane structure (1) is of tubular construction, the polymer membrane (3) being provided in particular on the inside and/or outside.

29. (canceled)

30. Degassing apparatus (6) having a membrane structure (1) for the gas separation, which is produced according to claim 1.

31. Degassing apparatus according to claim 30, characterised in that the membrane structure (1) is supported on the gas separation side.

32. Degassing apparatus according to claim 31, characterised in that the degassing apparatus (6) is constructed for separating gas from a liquid.

33. Degassing apparatus according to claim 32, characterised in that the degassing apparatus (6) is a liquid chromatograph.

34. Degassing apparatus (6) having a membrane structure (1) for the gas separation, which is constructed according to claim 12.

35. Degassing apparatus according to claim 34, characterized in that the membrane structure (1) is supported on the gas separation side.

36. Degassing apparatus according to claim 35, characterized in that the degassing apparatus (6) is constructed for separating gas from a liquid.

37. Degassing apparatus according to claim 36 characterized in that the degassing apparatus (6) is a liquid chromatograph.
